(19) United States
(12) Patent Application Publication
(10) Pub. No.: US 2024/0220311 A1
(43) Pub. Date: Jul. 4, 2024

(54) GENERATION DEVICE, GENERATION METHOD, AND GENERATION PROGRAM

(71) Applicant: Hitachi, Ltd., Tokyo (JP)

(72) Inventors: Ken NAONO, Tokyo (JP); Mika TAKATA, Tokyo (JP); Hiroaki MASUDA, Tokyo (JP)

(21) Appl. No.: 18/389,233

(22) Filed: Nov. 14, 2023

(30) Foreign Application Priority Data
Dec. 28, 2022 (JP) 2022-212111

(51) Int. Cl. G06F 9/48

(52) U.S. Cl. CPC G06F 9/48

(57) ABSTRACT

A generation device stores behavior information in which, for each of factors in a factor group, the factor is associated with a behavior taken when the factor is applicable. The processor executes an acquisition process of acquiring, for each of samples, a predicted probability based on whether or not each factor in the factor group is applicable and an importance level of each factor in the factor group which level is the basis for the predicted probability. An extraction process extracts a specific factor from the factor group on the basis of importance the levels obtained by the acquisition process, and a generation process acquires a specific behavior corresponding to the specific factor extracted by the extraction process, from the behavior information, and generates annotation information that presents the specific behavior to each sample to which the specific factor is applicable.

### CLAIM OF PRIORITY

The present application claims priority from Japanese patent application No. 2022-212111 filed on Dec. 28, 2022, the content of which is hereby incorporated by reference into this application.

### BACKGROUND OF THE INVENTION

### 1. Field of the Invention

The present invention relates to a generation device, a generation method, and a generation program that generate information.

### 2. Description of the Related Art

U.S. Patent Application Publication No. 2020/0160979 discloses a model-assisted annotation system. The model-assisted annotation system is operable to receive a first set of annotation data for a first set of medical scans from sets of client devices. A computer vision model is trained by utilizing the first set of medical scans and the first set of annotation data. A second set of annotation data for a second set of medical scans is generated by utilizing the computer vision model. The second set of medical scans and the second set of annotation data are transmitted to the set of client devices, and an additional set of annotation data is received in response. An updated computer vision model is generated by utilizing the additional set of annotation data. A third set of annotation data is generated for a third set of medical scans by utilizing the updated computer vision model for transmission to the set of client devices for display.

U.S. Patent Application Publication No. 2019/0236614 discloses a counterfeit detection system. The counterfeit detection system includes one or more data stores that store images of genuine items, and a processor. The processor executes instructions to obtain input images, determines a difference between a region of the image of a genuine item and a corresponding region of the input image by using a discriminator of generative adversarial networks (GANs), generates classification determining whether the input image is an image of the genuine item on the basis of the difference determined by the discriminator, identifies corresponding regions of the input image that has contributed to the classification, by a class activation module (CAM), obtains, by the CAM, an annotation indicating whether or not the corresponding regions indicate whether the input image is an image of a genuine item, and retrains the discriminator and/or the CAM on the basis of the annotation.

PCT Patent Publication No. WO2018/042272 discloses a system for retrieving medical images. The system includes an electronic processor configured to display an electronic medical image, collect (compile) clinical information associated with the electronic medical image, and determine a probability of a disease associated with a patient associated with the electronic medical image on the basis of the collected clinical information, and display the probability of the disease together with the medical image. The electronic processor is also configured to receive an annotation regarding the electronic medical image, determine an updated probability of the disease on the basis of the clinical information and the annotation, and display the updated probability of the disease.

Japanese Patent Laid-open No. 2017-174406 discloses a healthcare risk estimation system. This healthcare risk estimation system includes a risk-related term collection unit that collects terms including terms related to risks in the form of potential disability, terms related to risk factors that increase the likelihood of disability, and terms related to treatments for medical conditions, a medical entity reconciliator that uses a standard vocabulary of terms to standardize and extend clinicians' terms so as to include synonyms and equivalent terms, a topic detection and tagging unit that retrieves a group of documents linked to the expanded terms from a medical document database, a NERD module that extracts entities from the group of documents and adjusts each document with a standardized vocabulary, and a relation extraction unit that scores relations between two entities on the basis of co-occurrence of the entities in the obtained group of documents. The healthcare risk estimation system generates a risk knowledge graph that stores those relations.

### SUMMARY OF THE INVENTION

However, in U.S. Patent Application Publication Nos. 2020/0160979 and 2019/0236614, PCT Patent Publication No. WO2018/042272, and Japanese Patent Laid-open No. 2017-174406, annotation selection using important factors extracted from a factor group of explainable AI (explainable Artificial Intelligence: hereinafter referred to as an XAI) is not considered.

An object of the present invention is to optimize annotation selection.

A generation device that is one aspect of the invention disclosed in the present application includes a processor that executes a program and a storage device that stores the program. The generation device stores behavior information in which, for each of factors in a factor group, the factor is associated with a behavior taken when the factor is applicable. The processor executes an acquisition process of acquiring, for each of samples, a predicted probability based on whether or not each factor in the factor group is applicable and an importance level of each factor in the factor group which level is the basis for the predicted probability, an extraction process of extracting a specific factor from the factor group on the basis of the importance levels obtained by the acquisition process, and a generation process of acquiring a specific behavior corresponding to the specific factor extracted by the extraction process, from the behavior information, and generating annotation information that presents the specific behavior to each sample to which the specific factor is applicable.

According to a typical embodiment of the present invention, annotation selection can be optimized. Problems, configurations, and effects other than those described above will become clear by the description of the following examples.

### BRIEF DESCRIPTION OF THE DRAWINGS

FIG. 1 is an explanatory diagram illustrating an example of generation of annotation information;

FIG. 2 is a block diagram illustrating an example of a hardware configuration of a computer;

FIG. 3 is an explanatory diagram illustrating an example of a machine learning data set illustrated in FIG. 1;

FIG. 4 is an explanatory diagram illustrating an example of improvement behavior information;

FIG. 5 is an explanatory diagram illustrating an example of risk reduction behavior information;

FIG. 6 is a flowchart illustrating an example of an annotation information generation processing procedure by a generation device;

FIG. 7 is an explanatory diagram illustrating an example of an importance level matrix;

FIG. 8 is an explanatory diagram illustrating case 1 of combined information according to example 1;

FIG. 9 is an explanatory diagram illustrating case 2 of the combined information according to example 1;

FIG. 10 is an explanatory diagram illustrating case 1 of the annotation information;

FIG. 11 is an explanatory diagram illustrating case 2 of the annotation information;

FIG. 12 is an explanatory diagram illustrating case 3 of the annotation information;

FIG. 13 is an explanatory diagram illustrating an example of the risk reduction behavior information;

FIG. 14 is an explanatory diagram illustrating an example of combined information according to example 2;

FIG. 15 is an explanatory diagram illustrating modification example 1 of an annotation of the combined information;

FIG. 16 is an explanatory diagram illustrating modification example 2 of the annotation of the combined information; and

FIG. 17 is an explanatory diagram illustrating an example of combined behavior information.

### DESCRIPTION OF THE PREFERRED EMBODIMENTS

### Example 1

### <Example of Generating Annotation Information>

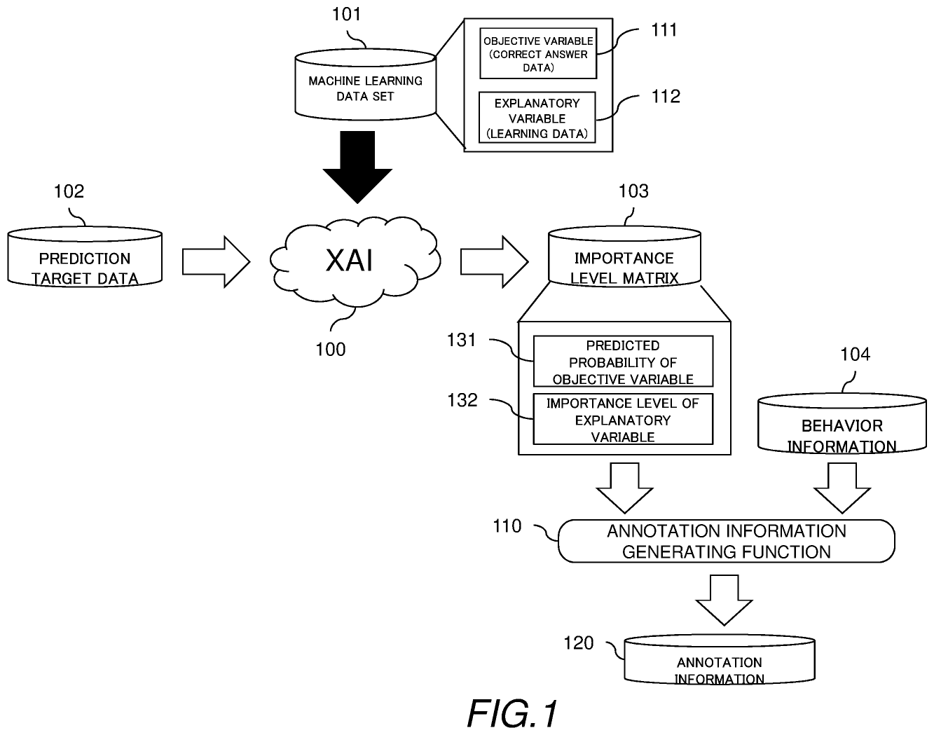

FIG. 1 is an explanatory diagram illustrating an example of generating annotation information. During learning, an XAI 100 is trained by using a machine learning data set 101. The machine learning data set 101 is a combination of an objective variable 111 called correct answer data and an explanatory variable 112 called learning data. The explanatory variable 112 is data having a value of each factor in a factor group for each sample (patient in this example). The factors are various test values for the patient, such as a body mass index (BMI) and a high density lipoprotein (HDL).

The objective variable 111 is the result corresponding to the factor value of each sample. In this example, it indicates self-support or care-need. The XAI 100 is trained so as to reduce the value of a loss function on the basis of the difference between the objective variable 111 and the output result obtained by inputting the explanatory variable 112 into the XAI 100.

During prediction, the XAI 100 receives an input of prediction target data 102. The prediction target data 102 has values of the same factor group as the explanatory variables 112. The prediction target data 102 may be at least a part of the explanatory variables 112. In the present example, for convenience of explanation, the explanatory variable 112 is used as the prediction target data 102, as it is.

When the prediction target data 102 is input, the XAI 100 outputs an importance level matrix 103. The importance level matrix 103 includes a predicted probability 131 of the objective variable 111 and an importance level 132 of the explanatory variable 112. The importance level 132 of the explanatory variable 112 is information indicating the basis for the XAI 100 calculating the predicted probability 131 of the objective variable 111.

Behavior information 104 is information in which a range of values that each factor constituting the explanatory variable 112 can take is associated with a recommended guideline for the prediction target having the prediction target data 102. In this example, the prediction target is a patient, and the recommended guideline is a behavior (such as smoking cessation) recommended for the patient.

An annotation information generating function 110 uses the importance level matrix 103 and the behavior information 104 to generate annotation information 120 for the prediction target. The annotation information 120 is information that includes a specific factor selected based on the importance level 132 of the explanatory variable 112, and a recommended guideline for the prediction target that is given as annotation with respect to the specific factor.

### <Example of Computer Hardware Configuration>

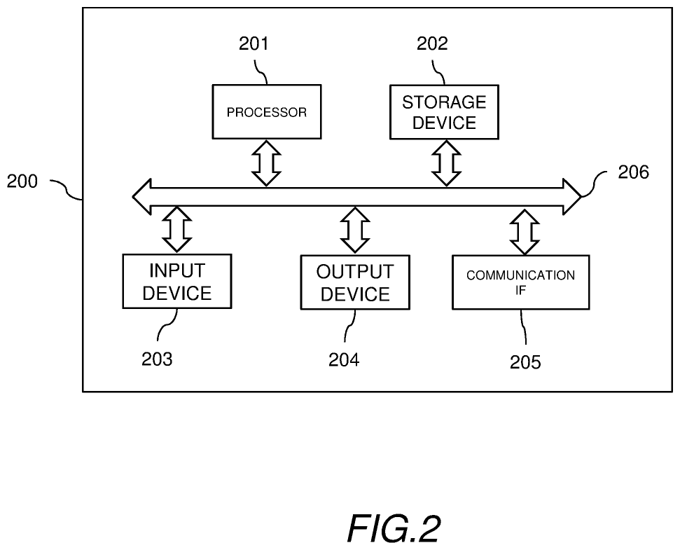

FIG. 2 is a block diagram illustrating an example of a hardware configuration of a computer. A computer 200 includes a processor 201, a storage device 202, an input device 203, an output device 204, and a communication interface (communication IF) 205. The processor 201, the storage device 202, the input device 203, the output device 204, and the communication IF 205 are connected to one another by a bus 206. The processor 201 controls the computer 200. The storage device 202 serves as a work area for the processor 201. Further, the storage device 202 is a non-temporary or temporary recording medium that stores various programs and data. Examples of the storage device 202 include a read only memory (ROM), a random access memory (RAM), a hard disk drive (HDD), and a flash memory. The input device 203 inputs data. Examples of the input device 203 include a keyboard, a mouse, a touch panel, a numeric keypad, a scanner, a microphone, and a sensor. The output device 204 outputs data. Examples of the output device 204 include a display, a printer, and a speaker. The communication IF 205 connects to a network and transmits and receives data.

The XAI 100 and the annotation information generating function 110 illustrated in FIG. 1 are implemented in the computer 200. The XAI 100 and the annotation information generating function 110 may be implemented in the same computer 200 or in different computers 200. The computer 200 in which at least the annotation information generating function 110 is implemented is referred to as a generation device. When the XAI 100 and the annotation information generating function 110 are implemented in different computers 200, the generation device receives the importance level matrix 103 from another computer in which the XAI 100 is implemented, via a network such as the Internet, a local area network (LAN), or a wide area network (WAN).

### <Machine Learning Data Set 101>

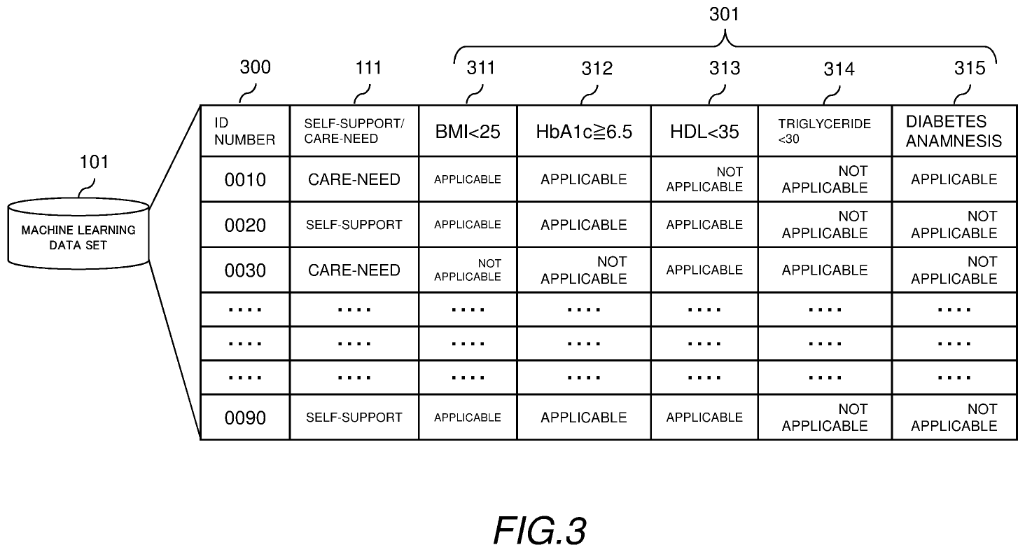

FIG. 3 is an explanatory diagram illustrating an example of the machine learning data set 101 illustrated in FIG. 1. The machine learning data set 101 has an ID number 300, the objective variable 111, and the explanatory variable 112. The ID number 300 is an identification number that uniquely identifies a sample (in this example, a patient). The objective variable 111 is correct answer data for the sample identified by the ID number 300, and in this example, is binary data indicating self-support or care-need.

The explanatory variable 112 is an aggregation of factors. In this example, a first factor 311 to a fifth factor 315 represent a group of factors constituting the explanatory variable 112, but the number of factors may be one to four, or six or more.

The first factor 311 indicates the applicability of BMI <25. The value of the first factor 311 is binary data indicating “applicable” or “not applicable.”

The second factor 312 indicates the applicability of HbA1c ≥6.5. The value of the second factor 312 is binary data indicating “applicable” or “not applicable.”

The third factor 313 indicates the applicability of HDL <35. The value of the third factor 313 is binary data indicating “applicable” or “not applicable.”

The fourth factor 314 indicates the applicability of triglyceride <30. The value of the fourth factor 314 is binary data indicating “applicable” or “not applicable.”

The fifth factor 315 indicates the applicability of diabetes anamnesis. The value of the fifth factor 315 is binary data indicating “applicable” or “not applicable.”

### <Improvement Behavior Information>

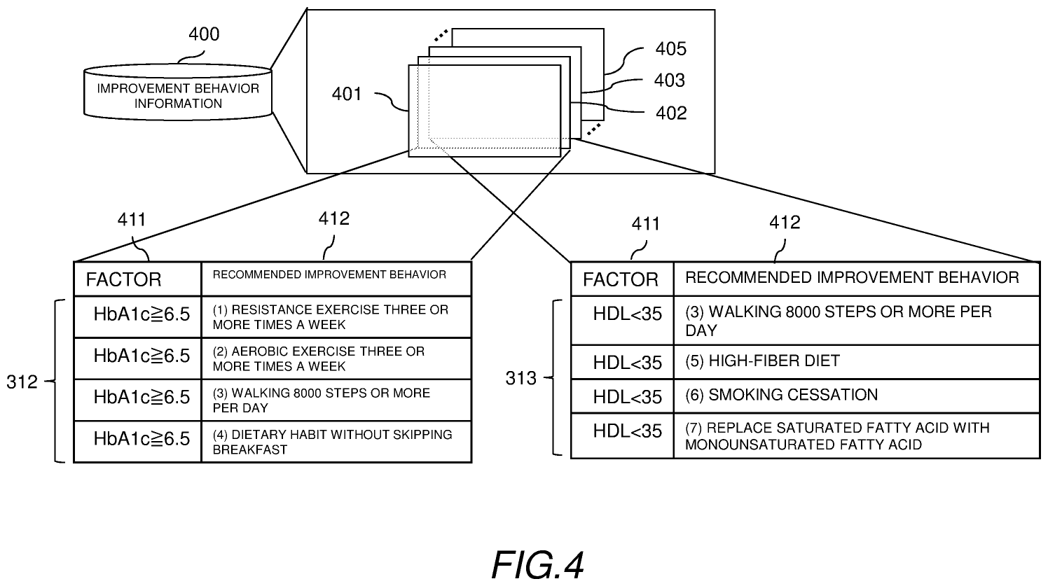

FIG. 4 is an explanatory diagram illustrating an example of improvement behavior information. Improvement behavior information 400 is information indicating a recommended improvement behavior for a factor 411. The improvement behavior information 400 is included in the behavior information 104. The improvement behavior information 400 includes first-factor improvement behavior information 401 to fifth-factor improvement behavior information 405 indicating a recommended improvement behavior for each factor 411 of the explanatory variable 112. For example, the second-factor improvement behavior information 402 is improvement behavior information regarding the second factor 312, and the third-factor improvement behavior information 403 is improvement behavior information regarding the third factor 313. The first-factor improvement behavior information 401 to fifth-factor improvement behavior information 405 each include the factor 411 and a recommended improvement behavior 412. The second-factor improvement behavior information 402 and the third-factor improvement behavior information 403 will be described below as examples.

The factor 411 of the second-factor improvement behavior information 402 is the second factor 312. The recommended improvement behavior 412 is an improvement behavior recommended when the factor 411 (second factor 312) is applicable. The number in parentheses in the recommended improvement behavior 412 indicates an identification number that uniquely identifies the behavior. Further, the recommended improvement behaviors 412 are listed in a priority order from the top in the table.

The factor 411 of the third-factor improvement behavior information 403 is the third factor 313. The recommended improvement behavior 412 is an improvement behavior recommended when the factor 411 (third factor 313) is applicable. The number in parentheses in the recommended improvement behavior 412 indicates an identification number that uniquely identifies the behavior. Further, the recommended improvement behaviors 412 are listed in a priority order from the top in the table.

### <Risk Reduction Behavior Information>

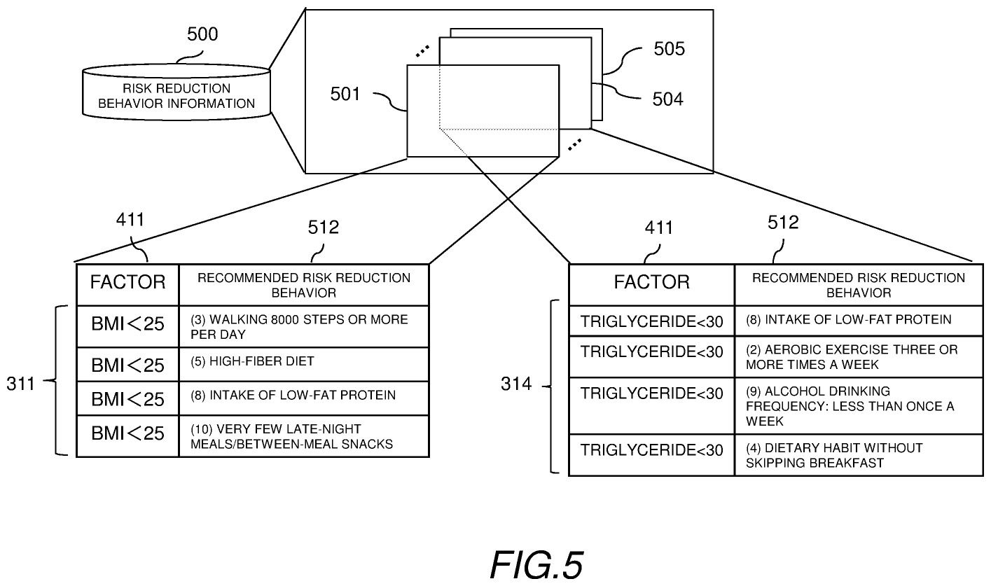

FIG. 5 is an explanatory diagram illustrating an example of risk reduction behavior information. Risk reduction behavior information 500 is information indicating a risk reduction behavior recommended for the factor 411. The risk reduction behavior information 500 is included in the behavior information 104. The risk reduction behavior information 500 includes first-factor risk-reduction-behavior information 501 to fifth-factor risk-reduction-behavior information 505 indicating a risk reduction behavior recommended for each factor 411 of the explanatory variable 112.

For example, the first-factor risk-reduction-behavior information 501 is risk reduction behavior information regarding the first factor 311, and the fourth-factor risk-reduction-behavior information 504 is risk reduction behavior information regarding the fourth factor 314. The first-factor risk-reduction-behavior information 501 to the fifth-factor risk-reduction-behavior information 505 each include the factor 411 and a recommended risk reduction behavior 512. Hereinafter, the first-factor risk-reduction-behavior information 501 and the fourth-factor risk-reduction-behavior information 504 will be described as examples.

The factor 411 of the first-factor risk-reduction-behavior information 501 is the first factor 311. The recommended risk reduction behavior 512 is a risk reduction behavior recommended when the factor 411 (first factor 311) is applicable. The number in parentheses in the recommended risk reduction behavior 512 indicates an identification number that uniquely identifies the behavior. Further, the recommended risk reduction behaviors 512 are listed in a priority order from the top in the table.

The factor 411 of the fourth-factor risk-reduction-behavior information 504 is the fourth factor 314. The recommended risk reduction behavior 512 is a risk reduction behavior recommended when the factor 411 (fourth factor 314) is applicable. The number in parentheses in the recommended risk reduction behavior 512 indicates an identification number that uniquely identifies the behavior. Further, the recommended risk reduction behaviors 512 are listed in a priority order from the top in the table.

### <Annotation Information Generation Processing Procedure>

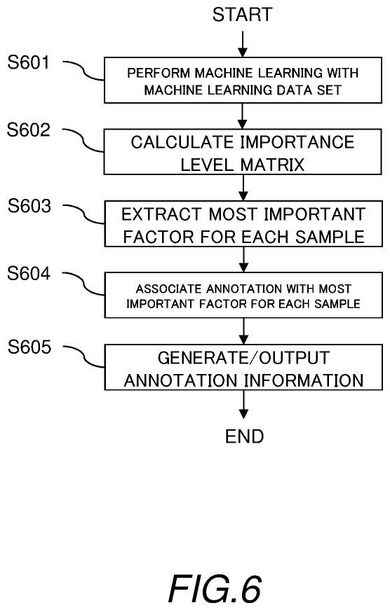

FIG. 6 is a flowchart illustrating an example of an annotation information generation processing procedure by the generation device. The generation device causes the XAI 100 to learn by performing machine learning using the machine learning data set 101 (step S601). Next, the generation device calculates the importance level matrix 103 by inputting the prediction target data 102 into the XAI 100 trained in step S601 (step S602).

Note that, if the generation device does not have the XAI 100 implemented therein, the generation device receives the importance level matrix 103 from another computer in which the XAI 100 is implemented, without executing steps S601 and S602.

### (Importance Level Matrix 103)

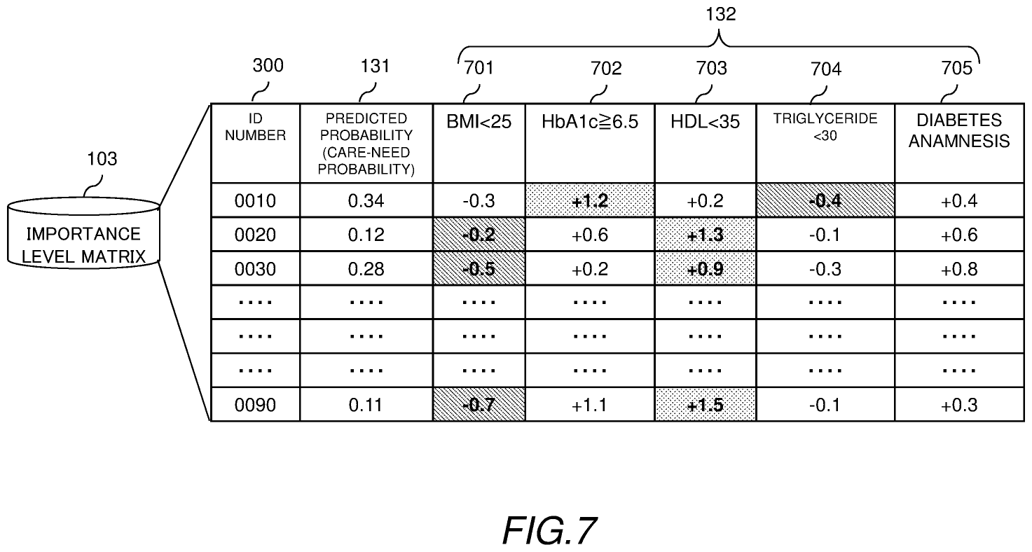

FIG. 7 is an explanatory diagram illustrating an example of the importance level matrix 103. In FIG. 7, for convenience of explanation, the importance level matrix 103 will be described in the form of a table structure. The importance level matrix 103 has the ID number 300, the predicted probability 131 of the objective variable 111, and the importance level 132 of the explanatory variable 112. The importance level 132 of the explanatory variable 112 has a first importance level 701 to a fifth importance level 705. The first importance level 701 to the fifth importance level 705 indicate the importance levels of the first factor 311 to the fifth factor 315.

A positive value of importance level indicates that the factor is a risk amplification factor, and a negative value of importance level indicates that the factor is a risk reduction factor. Note that the value of the importance level of 0.0 is included in either the risk amplification factor or the risk reduction factor, or is not included in either, depending on the setting.

Note that a shaded cell is a risk amplification factor that has a positive value and the highest importance level among the risk amplification factors in that sample, and is referred to as the most important risk amplification factor. A hatched cell is a risk reduction factor that has a negative value and the lowest importance level in that sample, and is referred to as the most important risk reduction factor.

For example, for a patient whose ID number 300 is “0020,” “BMI <25” specified by the first importance level 701 is the most important risk reduction factor, and “HDL <35” specified by the third importance level 703 is the most important risk amplification factor. When the most important risk amplification factor and the most important risk reduction factor are not distinguished from each other, they are each referred to as the most important factor.

Note that, even if the importance level is the minimum value in that sample, when the value is a positive value, the factor will not be the most important risk reduction factor. Similarly, in the sample, even if the importance value is the maximum value, when the value is 0.0 or a negative value, the factor will not be the most important risk amplification factor.

With reference back to FIG. 6, the generation device extracts the most important factor from the importance level matrix 103 for each sample (step S603). Next, the generation device associates the recommended improvement behavior 412 with the most important factor of each sample, as an annotation (step S604). Information in which the recommended improvement behavior 412 is associated as an annotation with the most important factor of each sample is referred to as combined information.

### (Combined Information)

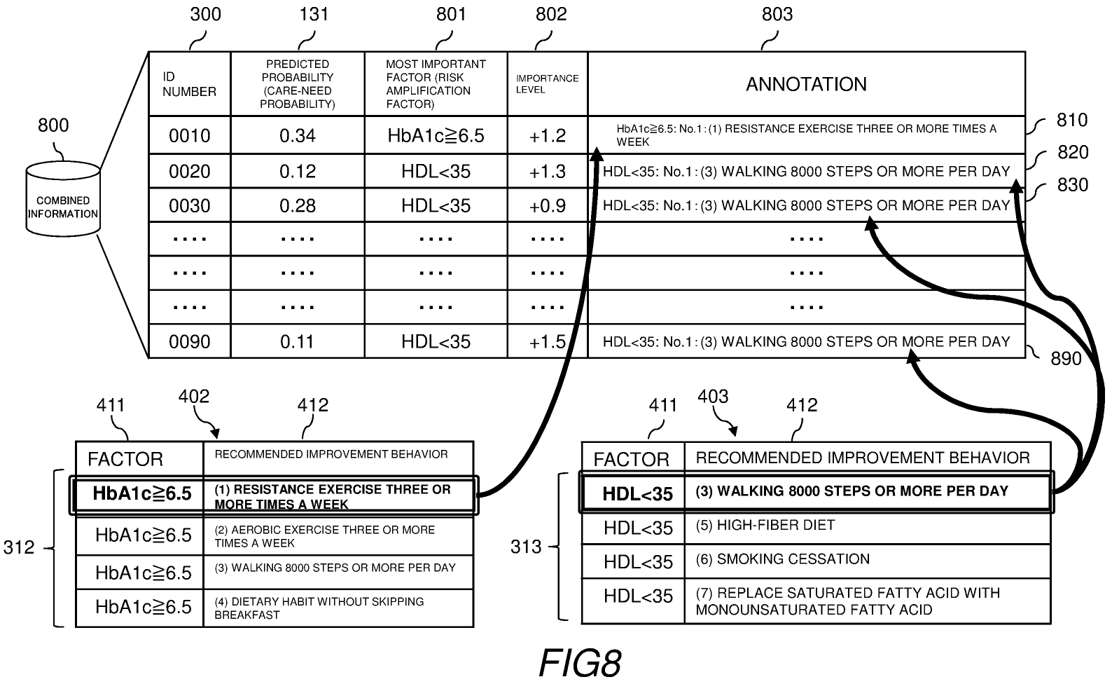

FIG. 8 is an explanatory diagram illustrating case 1 of the combined information according to example 1. Combined information 800 includes the ID number 300, the predicted probability 131 of the objective variable 111, a most important factor 801, an importance level 802, and an annotation 803.

In the combined information 800, the ID number 300 and the predicted probability 131 of the objective variable 111 are obtained from the importance level matrix 103. The most important factor 801 is the most important risk amplification factor selected for each sample. The importance level 802 is the importance level of the most important factor 801 in the importance level matrix 103.

The annotation 803 is selected from the improvement behavior information 400. To be specific, for example, the generation device selects the improvement behavior information 400 that corresponds to the most important factor 801 for each sample, and sets the recommended improvement behavior 412 of the selected improvement behavior information 400 in the annotation 803.

For example, in an entry 810 of a patient whose ID number 300 is “0010,” the most important factor 801 which is the most important risk amplification factor is “HbA1c ≥6.5.” Therefore, the generation device selects the second-factor improvement behavior information 402 related to the second factor 312 from the improvement behavior information 400, and selects one or more of the recommended improvement behaviors 412 thereof. The example in FIG. 8 illustrates an example in which “(1) Resistance exercise three or more times a week,” which is the recommended improvement behavior 412 with the highest priority, is selected. The generation device adds the selected recommended improvement behavior 412 as the annotation 803 to the entry 810 of the patient whose ID number 300 is “0010.”

Similarly, in entries 820, 830, and 890 for patients whose ID numbers 300 are “0020,” “0030,” and “0090,” respectively, the most important factor 801, which is the most important risk amplification factor, is “HDL <35.” Therefore, the generation device selects the third-factor improvement behavior information 403 related to the third factor 313 from the improvement behavior information 400, and selects one or more of the recommended improvement behaviors 412 thereof. The example in FIG. 8 illustrates an example in which “(3) walking 8,000 steps or more per day,” which is the recommended improvement behavior 412 with the highest priority, is selected. The generation device adds the selected recommended improvement behavior 412 as the annotation 803 to the entries 820, 830, and 890 of the patients whose ID numbers 300 are “0020,” “0030,” and “0090,” respectively.

In this way, the most important recommended improvement behaviors 412 for the individual patients are specified.

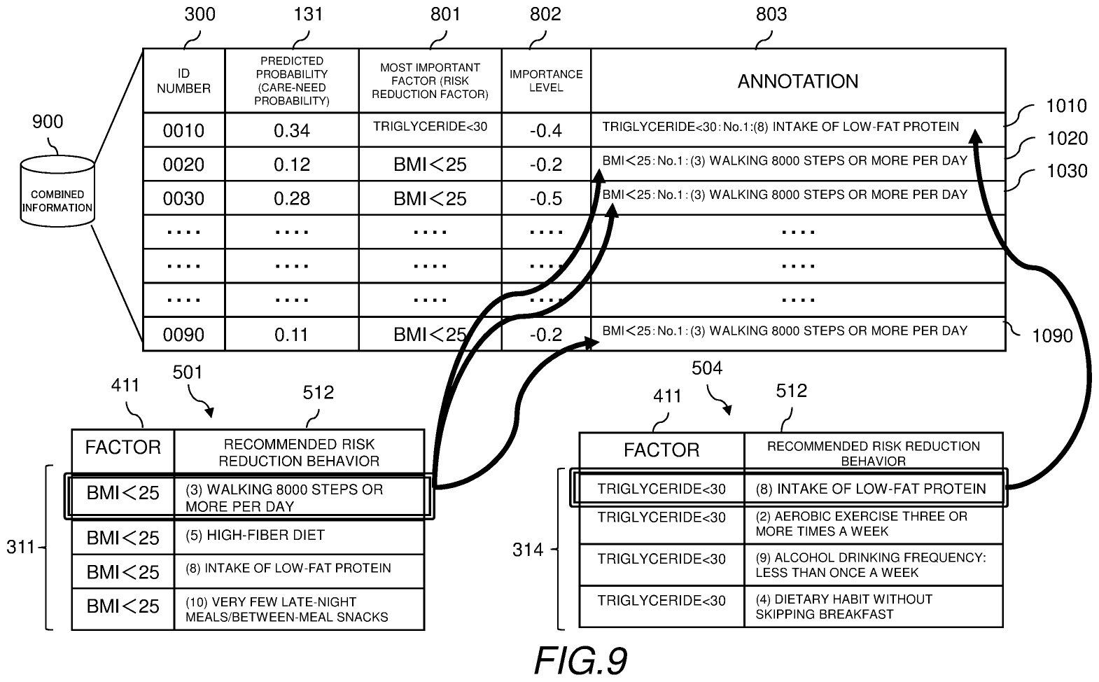

FIG. 9 is an explanatory diagram illustrating case 2 of the combined information according to example 1. Combined information 900 includes the ID number 300, the predicted probability 131 of the objective variable 111, the most important factor 801, the importance level 802, and the annotation 803.

In the combined information 900, the ID number 300 and the predicted probability 131 of the objective variable 111 are obtained from the importance level matrix 103. In FIG. 9, the most important factor 801 is the most important risk reduction factor whose importance level 802 selected for each sample is maximum. The importance level 802 is the importance level of the most important factor 801 in the importance level matrix 103.

The annotation 803 is selected from the improvement behavior information 400. To be specific, for example, the generation device selects the risk reduction behavior information 500 that corresponds to the most important factor 801 for each sample, and sets the recommended risk reduction behavior 512 of the selected risk reduction behavior information 500 in the annotation 803.

For example, in an entry 1010 of the patient whose ID number 300 is “0010,” the most important factor 801, which is the most important risk reduction factor, is “triglyceride <30.” Therefore, the generation device selects the fourth-factor risk-reduction-behavior information 504 related to the fourth factor 314 from the risk reduction behavior information 500, and selects one or more of the recommended risk reduction behaviors 512 thereof. The example in FIG. 9 illustrates an example in which “(8) intake of low-fat protein,” which is the recommended risk reduction behavior 512 with the highest priority, is selected. The generation device adds the selected recommended risk reduction behavior 512 as the annotation 803 to the entry 1010 of the patient whose ID number 300 is “0010.”

Similarly, in entries 1020, 1030, and 1090 for respective patients whose ID numbers 300 are “0020,” “0030,” and “0090,” the most important factor 801, which is the most important risk reduction factor, is “BMI <25.” Therefore, the generation device selects the first-factor risk-reduction-behavior information 501 related to the first factor 311 from the risk reduction behavior information 500, and selects one or more of the recommended risk reduction behaviors 512 thereof.

The example in FIG. 9 illustrates an example in which “(3) Walking 8,000 steps or more per day,” which is the recommended risk reduction behavior 512 with the highest priority, is selected. The generation device adds the selected recommended risk reduction behavior 512 as the annotation 803 to the entries 1020, 1030, and 1090 of respective patients whose ID numbers 300 are “0020,” “0030,” and “0090.”

In this way, the most important recommended risk reduction behaviors 512 for the individual patients are specified.

With reference back to FIG. 6, the generation device generates and outputs annotation information on the basis of the combined information 800 and 900 (step S605). The generated annotation information may be displayed on a display device that is an example of the output device 204 of the generation device, may be printed out from a printer that is an example of the output device 204 of the generation device, or may be transmitted to another computer in a displayable or printable form by the communication IF 205.

### (Annotation Information)

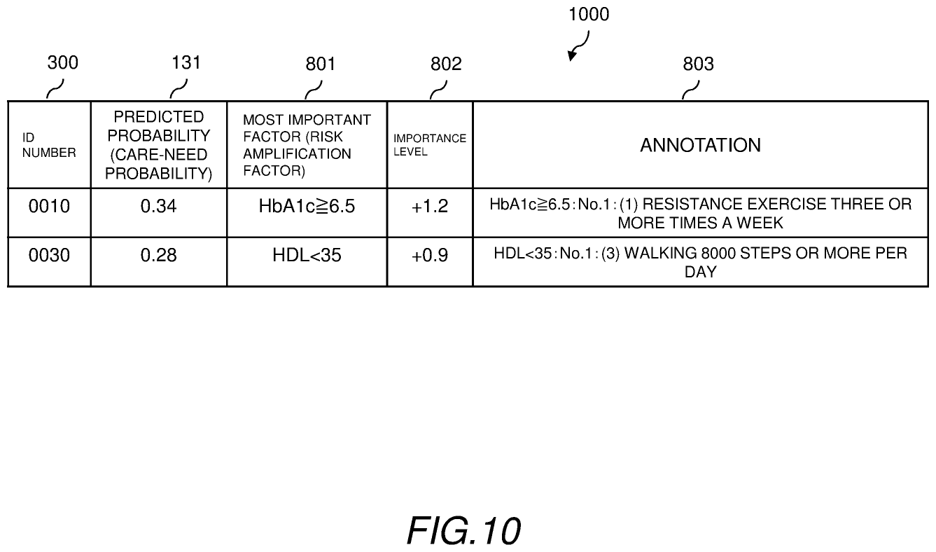

FIG. 10 is an explanatory diagram illustrating case 1 of annotation information. Like the combined information 800, annotation information 1000 includes the ID number 300, the predicted probability 131 of the objective variable 111, the most important factor 801, the importance level 802, and the annotation 803. The annotation information 1000 is information extracted after sorting entries of the combined information 800 in a descending order of the predicted probability 131 of the objective variable 111.

This clarifies the predicted probability 131 of the objective variable 111 (probability of care-need), namely, the important factor (most important factor 801) for reducing the risk of care-need, and the priority of behaviors to be taken as a group becomes clear. Note that the entries extracted from the combined information 800 may be entries from the first ranking to a predetermined ranking or may be all entries.

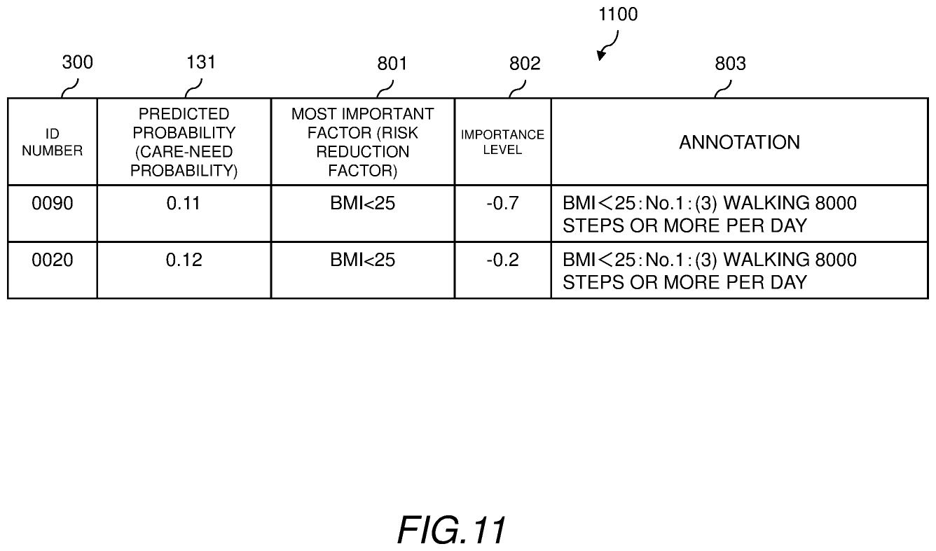

FIG. 11 is an explanatory diagram illustrating case 2 of annotation information. Like the combined information 900, annotation information 1100 includes the ID number 300, the predicted probability 131 of the objective variable 111, the most important factor 801, the importance level 802, and the annotation 803. The annotation information 1100 is information obtained by sorting entries of the combined information 900 in an ascending order of the predicted probability 131 of the objective variable 111 and performing extraction for each of the most important factors 801. FIG. 11 illustrates the annotation information 1100 obtained when the most important factor 801 is “BMI <25.”

As a result, in order to reduce the predicted probability 131 of the objective variable 111 (probability of care-need), for those who have not achieved “BMI <25,” which is the most important factor 801, practical information of those who have achieved (ID numbers 300 are “0090” and “0020”) can be clarified as collective intelligence. Note that the entries extracted from the combined information 900 for each most important factor 801 may be entries from the first ranking to a predetermined ranking or may be all entries corresponding to the most important factor 801.

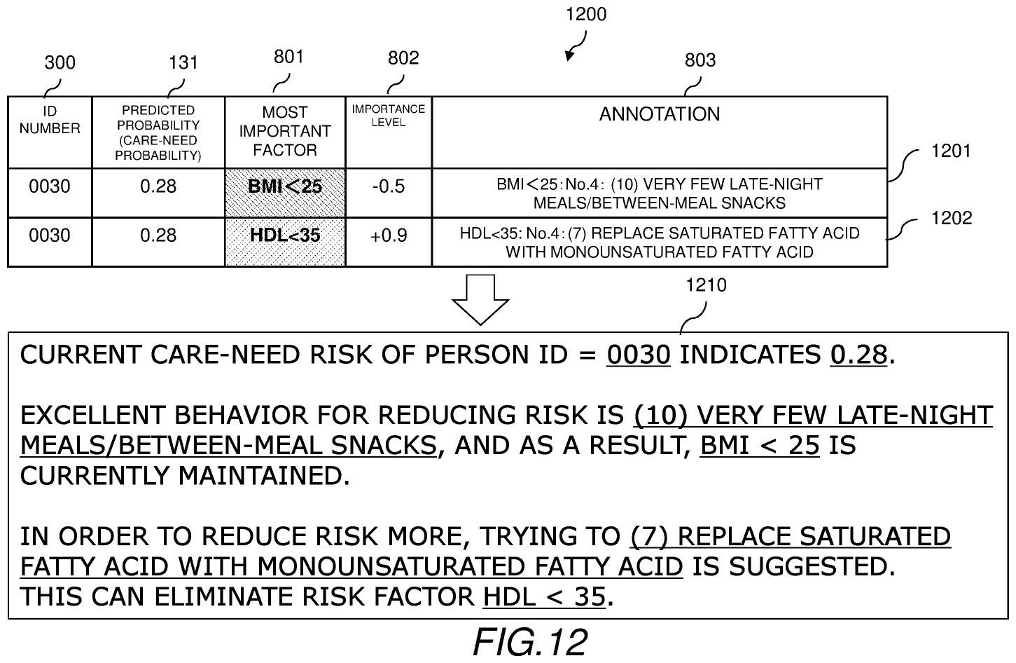

FIG. 12 is an explanatory diagram illustrating case 3 of annotation information. Like the combined information 800 and 900, annotation information 1200 includes the ID number 300, the predicted probability 131 of the objective variable 111, the most important factor 801, the importance level 802, and the annotation 803. The annotation information 1200 is information obtained by extracting entries of a risk reduction factor and a risk amplification factor included in the combined information 800 and 900 for each ID number 300. FIG. 12 illustrates the annotation information 1200 obtained when the ID number 300 is “0030.” An entry 1201 is an entry with the most important factor 801 being the risk reduction factor, and an entry 1202 is an entry with the most important factor 801 being the risk amplification factor.

Further, in step S605, the generation device may generate evaluation information 1210 in which the annotation information 1200 is converted into text by using a predetermined template, and may output the evaluation information 1210.

In this way, according to example 1, an annotation can be selected based on important factors extracted from the factor group of the XAI 100. Note that, in example 1, the most important factor 801 is applied in FIGS. 8 to 12, but the factor 411 whose importance level 802 is at the second ranking to a predetermined ranking or the factor 411 whose importance level 802 is equal to or higher than a threshold value may be applied as an important factor instead of or together with the most important factor 801.

### Example 2

Next, example 2 will be described. In example 1, an example is described in which the improvement behavior information 400 is used as the behavior information 104, but in example 2, an example in which risk reduction behavior information is used will be described. Note that, in example 2, since the description will focus on differences from example 1, the description of parts in common with example 1 will be omitted.

### <Risk Reduction Behavior Information>

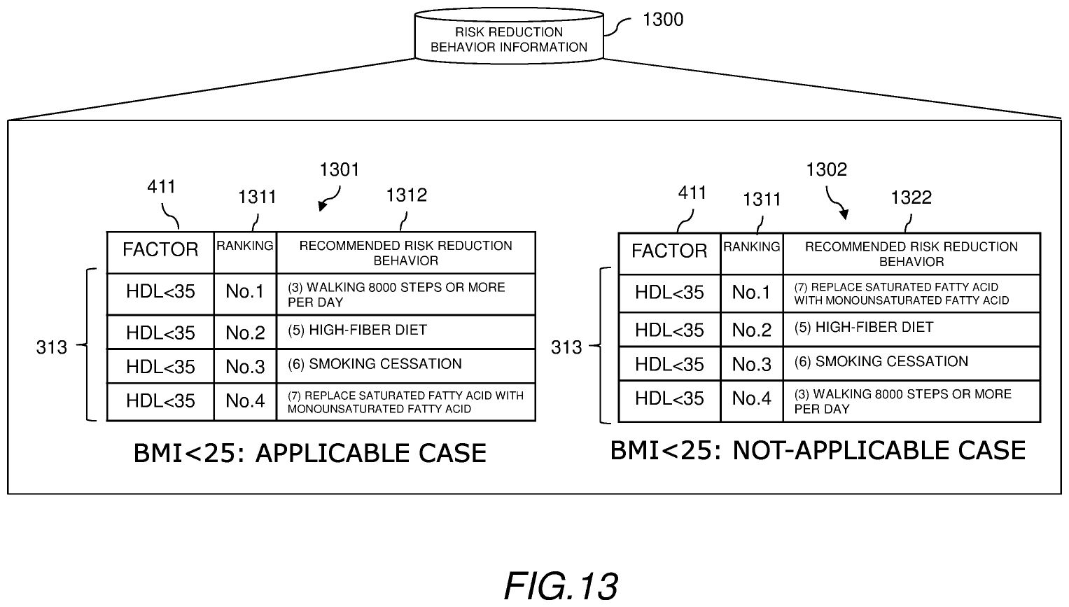

FIG. 13 is an explanatory diagram illustrating an example of risk reduction behavior information. Risk reduction behavior information 1300 is information indicating a risk reduction behavior recommended for the factor 411. The risk reduction behavior information 1300 is included in the behavior information 104. The risk reduction behavior information 1300 includes, for each factor 301 serving as a factor filter, factor-applicable risk-reduction-behavior information recommended for the factor 411 when the factor 301 is applicable, and factor-inapplicable risk-reduction-behavior information recommended for the factor 411 when the factor 301 is not applicable.

In FIG. 13, illustrated are first-factor-applicable risk-reduction-behavior information 1301 recommended for the factor 411 (third factor 313: HDL <35) when the first factor 311 (BMI <25) is applicable, and first-factor-inapplicable risk-reduction-behavior information 1302 recommended for the factor 411 (third factor 313: HDL <35) when the first factor 311 (BMI <25) is not applicable.

In this example, since the factor 301 includes the first factor 311 to the fifth factor 315, the behavior information 104 includes 20 sets of factor-applicable risk-reduction-behavior information and factor-inapplicable risk-reduction-behavior information. Hereinafter, the first-factor-applicable risk-reduction-behavior information 1301 and the first-factor-inapplicable risk-reduction-behavior information 1302 will be described as examples.

The factor 411 of the first-factor-applicable risk-reduction-behavior information 1301 and the first-factor-inapplicable risk-reduction-behavior information 1302 is the third factor 313. A ranking 1311 indicates the priority of a recommended risk reduction behavior 1312, which is set in advance. In the first-factor-applicable risk-reduction-behavior information 1301, the recommended risk reduction behavior 1312 is a risk reduction behavior recommended when the first factor 311 (BMI <25), which is a factor filter, is applicable. In the first-factor-inapplicable risk-reduction-behavior information 1302, a recommended risk reduction behavior 1322 is a risk reduction behavior recommended when the first factor 311 (BMI <25), which is a factor filter, is not applicable. The numbers in parentheses in the recommended risk reduction behavior 1312 indicate an identification number that uniquely identifies the behavior.

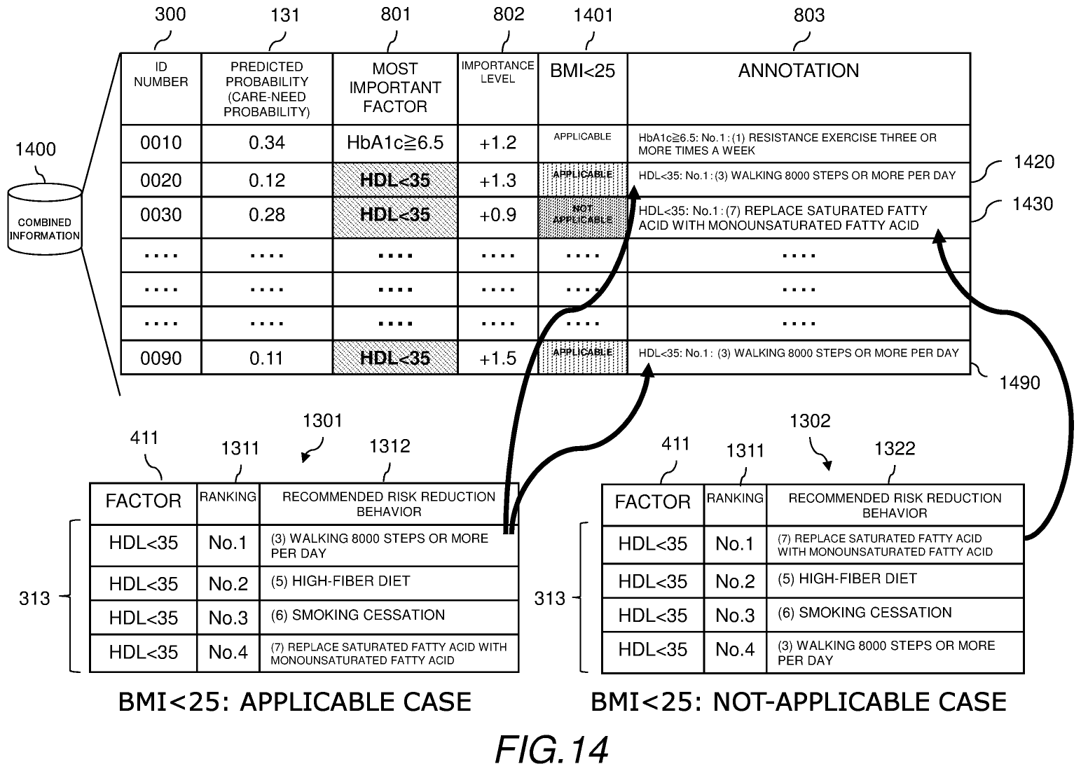

FIG. 14 is an explanatory diagram illustrating an example of combined information according to example 2. Combined information 1400 includes the ID number 300, the predicted probability 131 of the objective variable 111, the most important factor 801, the importance level 802, a factor filter 1401, and the annotation 803.

In the combined information 1400, the factor filter 1401 is information indicating whether a specific factor 411 is applicable to the sample identified by the ID number 300. In FIG. 14, the first factor 311 (BMI <25) is used as the specific factor 411, but the generation device may generate the combined information 1400 by applying each of the second to fifth factors 312 to 315 to the factor filter 1401.

In the example of FIG. 14, regarding an entry 1420, since the most important factor 801 is the third factor 313 and the factor filter 1401 (first factor 311: BMI <25) is “applicable,” “(3) Walking 8000 steps or more per day,” which is the recommended risk reduction behavior 1312 whose ranking 1311 in the first-factor-applicable risk-reduction-behavior information 1301 is the first place is added, together with the most important factor 801 (third factor 313: HDL <35), as the annotation 803.

In addition, regarding an entry 1430, since the most important factor 801 is the third factor 313 and the factor filter 1401 (first factor 311: BMI <25) is “not applicable,” “(7) Replace saturated fatty acid with monounsaturated fatty acid,” which is the recommended risk reduction behavior 1322 whose ranking 1311 in the first-factor-inapplicable risk-reduction-behavior information 1302 is the first place, is added together with the most important factor 801 (third factor 313: HDL <35), as the annotation 803.

In addition, regarding an entry 1490, since the most important factor 801 is the third factor 313 and the factor filter 1401 (first factor 311: BMI <25) is “applicable,” “(3) Walking 8000 steps or more per day,” which is the recommended risk reduction behavior 1312 whose ranking 1311 in the first-factor-applicable risk-reduction-behavior information 1301 is the first place, is added together with the most important factor 801 (third factor 313: HDL <35), as the annotation 803.

The generation device may apply each of the factors 301 to the factor filter 1401 to generate the combined information 1400 for each factor filter 1401, or may apply the factor 301 selected by a user of the generation device to the factor filter 1401 to generate the combined information 1400 for each factor filter 1401.

In this way, the generation device generates the combined information 1400 in step S604. Hence, the generation device can use the combined information 1400 to generate and output the annotation information 1000, 1100, and 1200 as illustrated in FIGS. 10 to 12.

### Example 3

Next, example 3 will be described. In example 3, an example of changing the annotation 803 of the combined information will be described. Note that, in example 3, since the description will focus on differences from examples 1 and 2, the description of parts in common with examples 1 and 2 will be omitted.

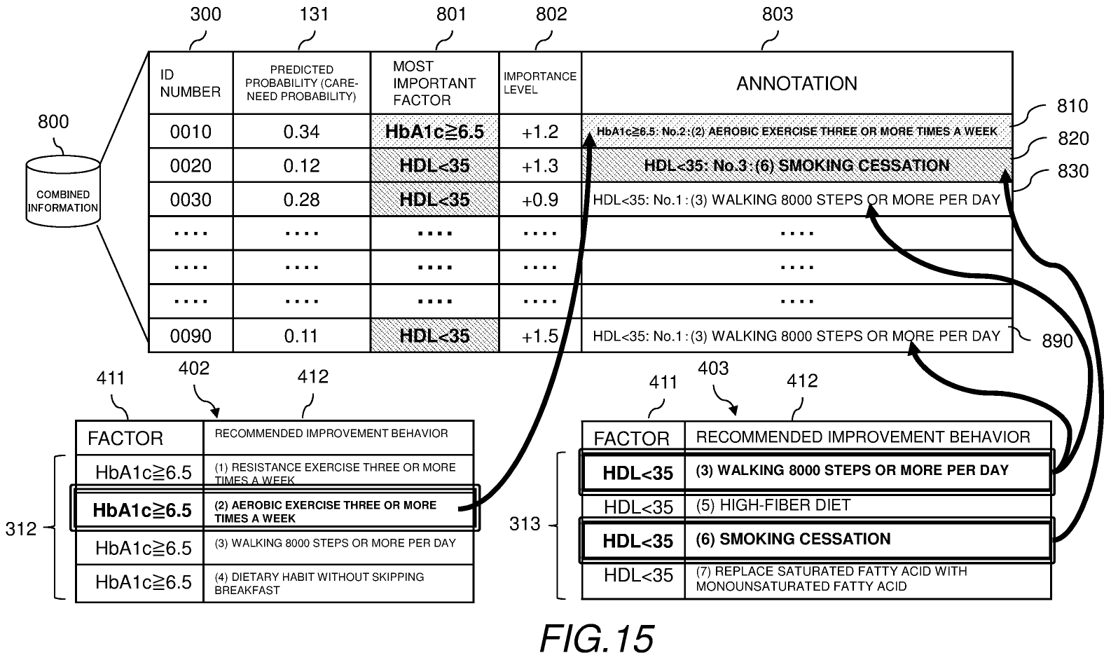

FIG. 15 is an explanatory diagram illustrating modification example 1 of the annotation 803 of the combined information 800. Comparing with FIG. 8, in the annotation 803 of the entry 810, “(1) Resistance exercise three or more times a week,” which is the recommended improvement behavior 412 of the second-factor improvement behavior information 402, has been changed to “(2) Aerobic exercise three or more times a week.”

Similarly, in the annotation 803 of the entry 820, “(3) Walking 8000 steps or more per day,” which is the recommended improvement behavior 412 of the third-factor improvement behavior information 403, has been changed to “(6) Smoking cessation.”

Such a change can be made by the user of the generation device selecting a recommended improvement behavior of the replacement, from the second-factor improvement behavior information 402 and the third-factor improvement behavior information 403 displayed on a display screen, by using the input device 203. Alternatively, this is executed by the generation device receiving a signal made when a user of a terminal that can communicate with the generation device selects a recommended improvement behavior of the replacement, from the second-factor improvement behavior information 402 and the third-factor improvement behavior information 403 displayed on a display screen of the terminal, by using the input device 203 of the terminal.

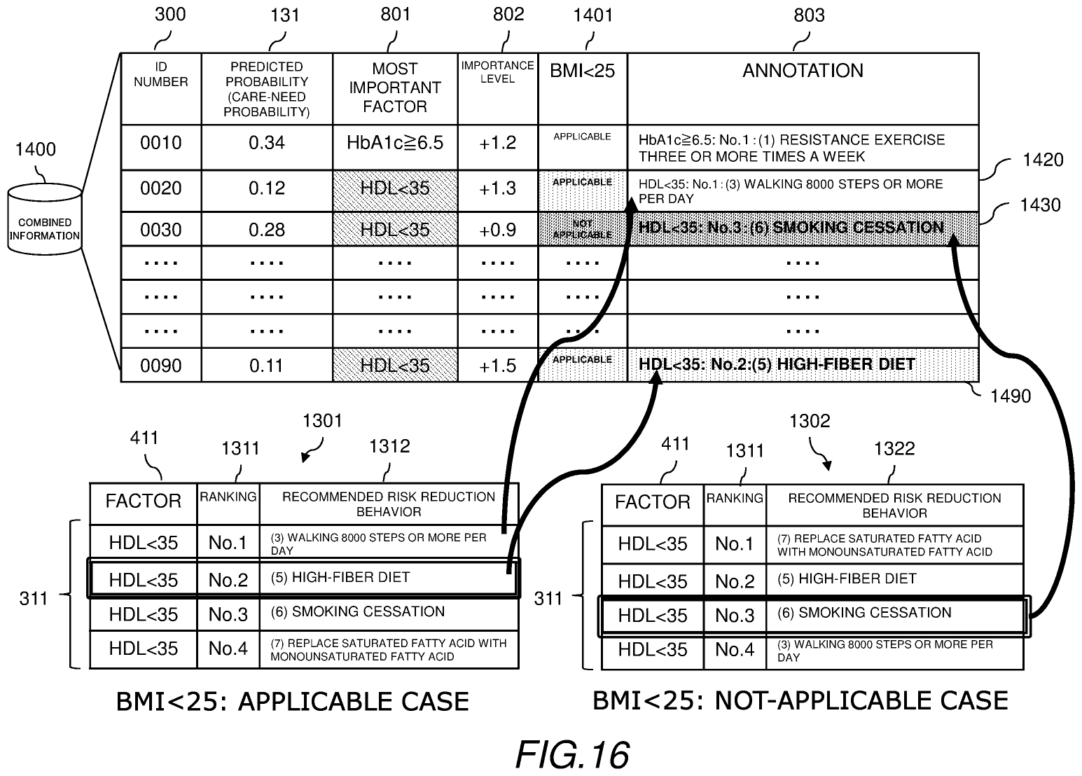

FIG. 16 is an explanatory diagram illustrating modification example 2 of the annotation 803 of the combined information 1400. Comparing with FIG. 14, in the annotation 803 of the entry 1430, “(7) Replace saturated fatty acid with monounsaturated fatty acid” which is the recommended risk reduction behavior 1322 of the first-factor-inapplicable risk-reduction-behavior information 1302, has been changed to “(6) Smoking cessation.”

Similarly, in the annotation 803 of the entry 1490, “(3) Walking 8000 steps or more per day,” which is the recommended risk reduction behavior 1312 of the first-factor-applicable risk-reduction-behavior information 1301, has been changed to “(5) High-fiber diet.”

Such a change can be made by the user of the generation device selecting a risk reduction behavior of the replacement by using the input device 203 from the first-factor-applicable risk-reduction-behavior information 1301 and the first-factor-inapplicable risk-reduction-behavior information 1302 displayed on the display screen. Alternatively, this is executed by the generation device receiving a signal made when a user of a terminal that can communicate with the generation device selects a risk reduction behavior of the replacement, by using the input device 203 of the terminal, from the first-factor-applicable risk-reduction-behavior information 1301 and the first-factor-inapplicable risk-reduction-behavior information 1302 displayed on a display screen of the terminal.

In this way, the generation device can change the annotation 803 of the combined information 800 and 900 by external operation. Therefore, the annotation 803 suitable for the sample identified by the ID number 300 can be provided.

### Example 4

Next, example 4 will be described. In example 4, an example in which combined behavior information is used as behavior information will be described. Note that, in example 4, since the description will focus on differences from examples 1 to 3, the description of parts in common with examples 1 to 3 will be omitted.

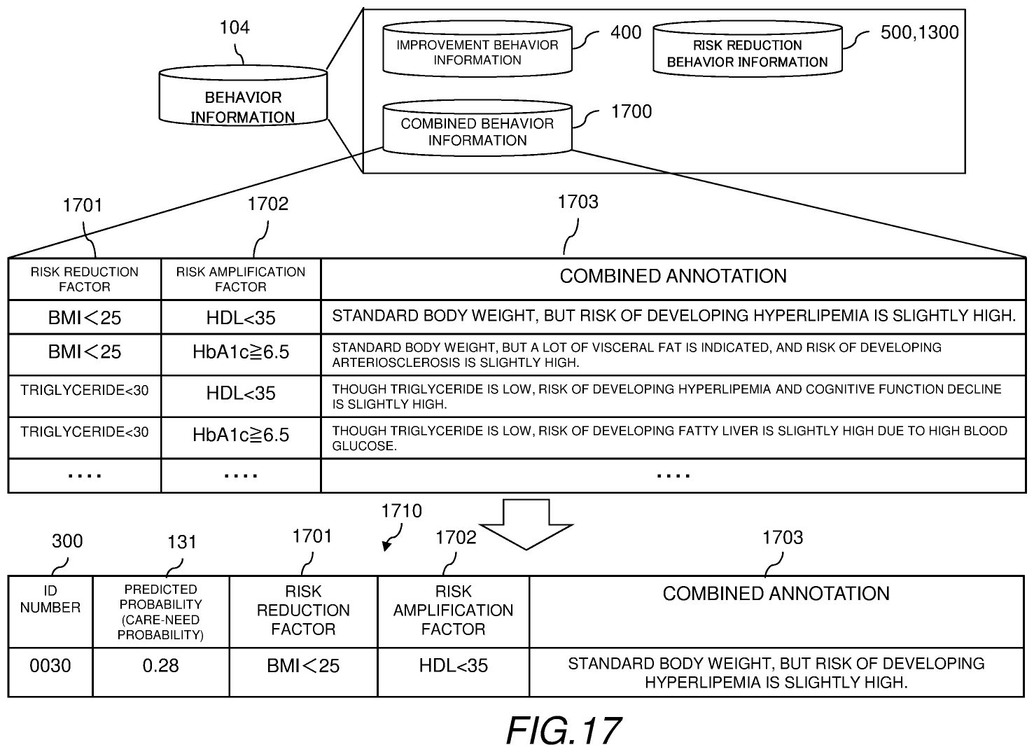

FIG. 17 is an explanatory diagram illustrating an example of the combined behavior information. Combined behavior information 1700 is included in the behavior information 104. The combined behavior information 1700 includes a risk reduction factor 1701, a risk amplification factor 1702, and a combined annotation 1703. The combined annotation 1703 is an annotation obtained by combining the risk reduction factor 1701 and the risk amplification factor 1702.

For example, in the importance level matrix 103, the risk reduction factor 1701 of the sample whose ID number 300 is “0030” is “BMI <25,” and the risk amplification factor 1702 thereof is “HDL <35.” Therefore, in step S604, the generation device selects the combined annotation 1703 of the entry in which the combination of the risk reduction factor 1701 and the risk amplification factor 1702 is “BMI <25” and “HDL <35,” and generates annotation information 1710 (step S605).

The annotation information 1710 includes the ID number 300, the predicted probability 131 of the objective variable 111, the risk reduction factor 1701, the risk amplification factor 1702, and the combined annotation 1703. Note that, in the case of example 4, there is no need to execute step S604.

In this way, according to example 4, the combined annotation 1703 depending on the sample can be provided.

As described above, according to examples 1 to 4 described above, annotation selection can be optimized.

Note that the present invention is not limited to the examples described above and includes various modifications and equivalent configurations within the scope of the appended claims. For example, the abovementioned examples are described in detail to describe the present invention in an easy-to-understand manner, and the present invention is not necessarily limited to one having all the described configurations. Further, a part of the configuration of one example may be replaced with a configuration of another example. Further, a configuration of one example may be added to the configuration of another example. Further, other configurations may be added to, deleted from, or substituted for a part of the configuration of each example.

Further, each of the above-mentioned configurations, functions, processing units, processing means, etc. may be achieved in part or in whole by hardware, for example, by designing with integrated circuits, or by software by a processor interpreting and executing a program for implementing each function.

Information such as programs for implementing each function, tables, and files can be stored in a storage device such as a memory, a hard disk, a solid state drive (SSD), or a storage medium such as an integrated circuit (IC) card, an SD card, a digital versatile disc (DVD).

Furthermore, the control lines and information lines illustrated are those considered necessary for description, and all the control lines and information lines necessary for implementation are not necessarily illustrated. In reality, almost all configurations can be considered to be interconnected.

What is claimed is:

1. A generation device comprising:
a processor that executes a program; and
a storage device that stores the program, wherein
behavior information in which, for each of factors in a factor group, the factor is associated with a behavior taken when the factor is applicable is stored, and
the processor executes
an acquisition process of acquiring, for each of samples, a predicted probability based on whether or not each factor in the factor group is applicable and an importance level of each factor in the factor group which level is a basis for the predicted probability,
an extraction process of extracting a specific factor from the factor group on a basis of the importance levels obtained by the acquisition process, and
a generation process of acquiring a specific behavior corresponding to the specific factor extracted by the extraction process, from the behavior information, and generating annotation information that presents the specific behavior to each sample to which the specific factor is applicable.

2. The generation device according to claim 1, wherein
the behavior information includes improvement behavior information in which each factor is associated with an improvement behavior recommended for the samples when the factor is applicable,
in the extraction process, the processor extracts a factor for which the importance level is greater than a threshold value, as the specific factor, and,
in the generation process, the processor acquires a specific improvement behavior corresponding to the specific factor from the improvement behavior information, and generates annotation information that presents the specific improvement behavior to each sample to which the specific factor is applicable.

3. The generation device according to claim 2, wherein,
in the extraction process, the processor extracts a factor for which the importance level is greater than the threshold value and is maximum, as the specific factor.

4. The generation device according to claim 1, wherein
the behavior information includes risk reduction behavior information in which each factor is associated with a risk reduction behavior recommended for the samples when the factor is applicable,
in the extraction process, the processor extracts a factor for which the importance level is smaller than a threshold value, as the specific factor, and,
in the generation process, the processor acquires a specific risk reduction behavior corresponding to the specific factor from the risk reduction behavior information, and generates annotation information that presents the specific risk reduction behavior to each sample to which the specific factor is applicable.

5. The generation device according to claim 4, wherein,
in the extraction process, the processor extracts a factor for which the importance level is smaller than the threshold value and is minimum, as the specific factor.

6. The generation device according to claim 1, wherein,
in the generation process, the processor generates the annotation information for a sample for which the predicted probability is equal to or higher than a predetermined probability or is at a predetermined ranking or higher.

7. The generation device according to claim 1, wherein
the behavior information includes, for each of second factors other than a first factor in the factor group, first-factor-applicable risk-reduction-behavior information in which the second factor is associated with a risk reduction behavior recommended for each sample when the first factor and the second factor are applicable to the sample,
in the extraction process, the processor extracts a second factor for which the importance level is smaller than a threshold value, as a specific second factor, and,
in the generation process, the processor acquires, for a specific sample to which the first factor is applicable, a specific risk reduction behavior corresponding to the specific second factor from the first-factor-applicable risk-reduction-behavior information, and generates annotation information that presents the specific risk reduction behavior to the specific sample to which the specific second factor is applicable.

8. The generation device according to claim 1, wherein
the behavior information includes, for each of second factors other than a first factor in the factor group, first-factor-inapplicable risk-reduction-behavior information in which the second factor is associated with a risk reduction behavior recommended for each sample when the first factor is not applicable to the sample but the second factor is applicable to the sample,
in the extraction process, the processor extracts a second factor for which the importance level is smaller than a threshold value, as a specific second factor, and,
in the generation process, the processor acquires, for a specific sample to which the first factor is not applicable, a specific risk reduction behavior corresponding to the specific second factor from the first-factor-inapplicable risk-reduction-behavior information, and generates annotation information that presents the specific risk reduction behavior to the specific sample to which the specific second factor is applicable.

9. The generation device according to claim 1, wherein
the behavior information includes combined behavior information in which a combination of a risk amplification factor and a risk reduction factor in the factor group is associated with a behavior taken when the combination is applicable,
in the extraction process, the processor extracts, for each sample, a combination of a specific risk amplification factor and a specific risk reduction factor from the factor group, on the basis of the importance levels acquired by the acquisition process, and,
in the generation process, the processor acquires a specific behavior corresponding to the combination of the specific risk amplification factor and the specific risk reduction factor extracted by the extraction process, from the combined behavior information, and generates annotation information that presents the specific behavior to each sample to which the combination of the specific risk amplification factor and the specific risk reduction factor is applicable.

10. A generation method executed by a generation device having a processor that executes a program and a storage device that stores the program, wherein
the generation device stores behavior information in which, for each of factors in a factor group, the factor is associated with a behavior taken when the factor is applicable, and
the processor executes
an acquisition process of acquiring, for each of samples, a predicted probability based on whether or not each factor in the factor group is applicable and an importance level of each factor in the factor group which level is a basis for the predicted probability,
an extraction process of extracting a specific factor from the factor group on a basis of the importance levels obtained by the acquisition process, and
a generation process of acquiring a specific behavior corresponding to the specific factor extracted by the extraction process, from the behavior information, and generating annotation information that presents the specific behavior to each sample to which the specific factor is applicable.

11. A generation program that causes a processor capable of accessing behavior information in which, for each of factors in a factor group, the factor is associated with a behavior taken when the factor is applicable, to execute:
an acquisition process of acquiring, for each of samples, a predicted probability based on whether or not each factor in the factor group is applicable and an importance level of each factor in the factor group which level is a basis for the predicted probability;
an extraction process of extracting a specific factor from the factor group on a basis of the importance levels obtained by the acquisition process; and
a generation process of acquiring a specific behavior corresponding to the specific factor extracted by the extraction process, from the behavior information, and generating annotation information that presents the specific behavior to each sample to which the specific factor is applicable.
